(19) United States
(12) Patent Application Publication
(10) Pub. No.: US 2021/0139047 A1
(43) Pub. Date: May 13, 2021

(54) METHOD AND DEVICE FOR SAFE PASSING OF A VEHICLE APPROACHING A BICYCLE

(71) Applicant: Robert Bosch GmbH, Stuttgart (DE)

(72) Inventor: Daniel Geldner, Tiefenbronn (DE)

(21) Appl. No.: 17/047,911

(22) PCT Filed: May 27, 2019
(86) PCT No.: PCT/EP2019/063698

§ 371 Date: Oct. 15, 2020

(30) Foreign Application Priority Data
Sep. 4, 2018 (DE) 10 2018 214 962.3

(51) Int. Cl. B60W 60/00; B60W 30/18; B60W 30/16; B60W 40/08; B60W 50/00; B60Q 1/34; B60W 50/14

(52) U.S. Cl. CPC B60W 60/0015; B60W 30/18163; B60W 30/16; B60W 40/08; B60W 50/0097; B60W 2554/80; B60Q 1/346; B60W 50/14; B60W 2555/60; B60W 2552/53; B60W 2554/4026; B60W 60/0027

(57) ABSTRACT

A method for safe passing of a vehicle approaching a bicycle. In the method, a future path of the vehicle is altered in an automated manner if a safety distance with respect to a probable trajectory of the bicycle is undershot, the vehicle being guided on the altered path if it extends within an available traffic space.

### FIELD

The present invention relates to a method and a device for safe passing of a vehicle approaching a bicycle.

### BACKGROUND INFORMATION

Different assistance systems may be implemented in a vehicle.

For example, an adaptive cruise control is able to hold the vehicle at a set target speed as long as a safety distance to a preceding vehicle, adapted to the target speed, is maintained. If the safety distance is undershot, the adaptive cruise control reduces the speed until the vehicle travels at the speed of the preceding vehicle and follows the preceding vehicle at a safety distance adapted to the reduced speed.

### SUMMARY

In accordance with the present invention, a method for safe passing of a vehicle approaching a bicycle and a device for safe passing of a vehicle approaching a bicycle and, finally, a corresponding computer program and a machine readable memory medium are provided. Advantageous example embodiments, refinements and improvements thereof result from the description herein and the figures.

In addition to a longitudinal safety distance with respect to a bicycle, specific embodiments of the present invention may advantageously enable a lateral safety distance to be maintained with respect to the bicycle. In this case, the lateral safety distance may also be maintained even in a constricted traffic space.

A method is provided for safe passing of a vehicle approaching a bicycle, which is characterized in that a future path of the vehicle is altered in an automated manner if a safety distance with respect to a probable trajectory of the bicycle is undershot, the vehicle being guided along the altered path if it extends within an available traffic space.

Ideas relating to specific embodiments of the present invention may be considered to be based on, among other things, the features and findings described below.

Using pieces of sensor information of a sensor system of the vehicle effective at long and medium distances, for example, of a camera system and/or of a radar system and/or of a LIDAR system, it is possible to identify a cyclist on a bicycle in an automated manner. An instantaneous direction and instantaneous speed of the cyclist may also be determined from the pieces of sensor information. Using these pieces of information, it is possible to predict a probability range in which the cyclist will move with a high degree of probability within an observation period. The probability range may be described by a probable trajectory of the bicycle. A future path of the vehicle may be predetermined by a driver assistance system of the vehicle, for example, by a lane-keeping assistant.

When passing a cyclist, a safety distance between a right boundary of the vehicle and a left boundary of the bicycle or cyclist of at least 1.5 meters is to be maintained. Accordingly, the opposite sides for left-hand traffic. The safety distance may also be greater as a function of a speed of the vehicle. In addition, the required safety distance may be greater if a child is being transported on the bicycle. The future path of the vehicle is adapted automatically to the altered path in such a way that the safety distance is at least maintained.

The future path of the vehicle may be altered in an automated manner based on the pieces of sensor information. The available traffic space may be ascertained in an automated manner based on the pieces of sensor information. The available traffic space is delimited by other road users, roadway boundaries and the applicable traffic regulations. Within the available traffic space, the vehicle is able to travel conflict-free. When sufficient traffic space is available, the vehicle is able to travel past the bicycle while maintaining the safety distance. When no sufficient traffic space is available, the vehicle is unable to be safely driven on the altered path.

A speed of the vehicle may be altered if the altered path extends beyond or at least partially beyond the available traffic space. The vehicle may be decelerated if there is not enough space to the left of the bicycle for passing. The bicycle may then be used, for example, as a target vehicle for an adaptive cruise control of the vehicle.

The future path of the vehicle may then be re-determined using the altered speed and the method may be repeated. If the vehicle travels slower, a safety distance shorter than prior to the reduction in speed may be required.

The future path may be predicted using an instantaneous driver input. The future path may be predicted from an instantaneous travel direction, from an instantaneous speed, from an instantaneous steering movement and from an instantaneous accelerating requirement or a brake demand.

The driver input may be opposed by a counterforce if the driver input deviates from the altered path and/or the altered speed. As in the case of a lane keeping assistant, the driver may be assisted during steering.

Alternatively or in addition, a warning may be output if the driver input deviates from the altered path and/or from the altered speed. The warning may be output in an acoustic, visual and/or haptic manner. With the warning, the driver may be warned against falling short of the safety distance and/or may maintain the safety distance him/herself.

The available traffic space may be determined using a piece of traffic sign information representing identified traffic signs and/or a piece of roadway marking information representing identified roadway markings. Traffic signs and roadway markings may be identified in the sensor information. When passing the bicycle, it is possible to maintain the prevailing traffic regulations. For example, an instantaneous speed limit and/or a no-passing zone may be identified by the erected traffic signs and/or via the roadway marking.

The available traffic space may be determined using a piece of on-coming traffic information representing an identified on-coming traffic path. Other road users, in particular, on-coming vehicles, restrict the traffic space available for passing. The passing may be halted if sufficient space is not available due to other road users.

A turn signal device of the vehicle may be activated before and during the passing. The passing may be indicated by automatic blinking. The blinking draws the attention of the following vehicles to the cyclist.

The method may be implemented in software or in hardware or in a mixed form of software and hardware, for example, in a control unit.

The approach presented herein further provides a device, which is designed to carry out, control or implement the steps of a variant of the method provided herein in corresponding units.

The device may be an electrical device including at least one processing unit for processing signals or data, at least one memory unit for storing signals or data, and at least one interface and/or a communication interface for reading in or outputting data, which are embedded in a communication protocol. The processing unit may, for example, be a signal processor, a so-called system ASIC or a microcontroller for processing sensor signals and outputting data signals as a function of the sensor signals. The memory unit may, for example, be a flash memory, an EPROM or a magnetic memory unit. The interface may be designed as a sensor interface for reading in the sensor signals from a sensor and/or as an actuator interface for outputting the data signals and/or control signals to an actuator. The communication interface may be designed to read in or output data wirelessly and/or in a hardwired manner. The interfaces may also be software modules, which are present on a microcontroller, for example, along with other software modules.

Also advantageous is a computer program product or computer program having program code, which may be stored on a machine-readable medium or memory medium, such as a semiconductor memory, a hard disk memory or an optical memory, and which is used for carrying out, implementing and/or activating the steps of the method according to one of the previously described specific embodiments, in particular, when the program product or program is executed on a computer or a device.

It is noted that some of the possible features and advantages of the present invention are described herein with reference to different specific embodiments. Those skilled in the art recognize that the features of the device and of the method may be combined, adapted or interchanged in a suitable manner in order to arrive at further specific embodiments of the present invention.

### BRIEF DESCRIPTION OF THE DRAWINGS

Specific embodiments of the present invention are described below with reference to the figures; neither the figures nor the description are to be interpreted as restricting the present invention.

FIGS. 1 through 3 show representations of possible scenarios during passing of bicycles.

The figures are merely schematic and not true to scale. Identical reference numerals in the figures refer to identical features or features having the same effect.

### DETAILED DESCRIPTION OF EXAMPLE EMBODIMENTS

Cyclists are passed on country roads every day. The lateral distance in such cases is often not maintained. This is unpleasant for the cyclist on the one hand, and may become very hazardous on the other hand.

This may be avoided with the approach presented herein using the present generation of driver assistance systems. The “safe cyclist passing” presented herein may be implemented, for example, as an extension of the ACC function (adaptive cruise control). In this case an automatic passing maneuver is initiated when driving with activated ACC and a cyclist is travelling ahead in his/her own lane.

FIGS. 1 through 3 show representations of possible scenarios during passing of bicycles 100. In each scenario, a bicycle 100 is traveling ahead of a vehicle 102 on a road 104 that includes one traffic lane 106 each per travel direction, i.e., a typical country road, for example. Vehicle 102 is travelling faster than bicycle 100. Bicycle 100 is travelling on the right margin of the traffic lane 106, on which vehicle 102 is approaching bicycle 100 from behind. To be able to pass bicycle 100 at required safety distance 108 of at least 1.5 meters, it is always necessary in the scenarios depicted here to swerve into the other traffic lane 106.

Vehicle 102 includes a device according to the approach presented herein, on which a method for safe passing according to one exemplary embodiment is carried out. The device processes pieces of sensor information of a sensor system of vehicle 102 in order to identify road 104, the travel lanes, the traffic signs and other road users, such as bicycle 100. A future path 110 of vehicle 102 is read in by the device, for example, from a navigation system of vehicle 102. Future path 110 may also be read in from a driver assistance system of vehicle 102. Alternatively, future path 110 may be extrapolated from instantaneous driver inputs, such as a steering wheel position, an accelerator pedal position and/or a brake pedal position.

From the pieces of sensor information, the device further determines a probable trajectory 112 of bicycle 100. The probable trajectory in this case is extrapolated using an instantaneous speed and direction of bicycle 100.

FIG. 1 depicts how future path 110 is automatically altered by the device if safety distance 108 with respect to probable trajectory 112 of bicycle 100 is undershot. An altered path 114 extends further to the left as viewed from vehicle 102. Vehicle 102 is guided by the device via control signals on altered path 114. On altered path 114, vehicle 102 maintains at least a 1.5 meter safety distance 108 with respect to bicycle 100. Vehicle 102 is guided at least partially on an arc across opposite travel lane 106, since in the absence of on-coming traffic and in the absence of a no-passing zone, an available traffic space 116 is sufficiently large for such purpose.

In one exemplary embodiment, a left blinker of vehicle 102 is automatically set before vehicle 102 initiates the passing on altered path 114.

FIG. 2 depicts how safety distance 108 would be undershot by future path 110, since vehicle 102 could pass bicycle 100 only at a maximum distance of one meter due to a solid center line 200. Altered path 114 which, at a sufficient safety distance 108, would lead past the bicycle, crosses center line 200 and is thus situated beyond available traffic space 116. Thus, bicycle 100 is classified as a preceding vehicle and a speed of vehicle 102 is adapted to a speed of bicycle 100 until the no-passing zone ends and, in addition, available traffic space 116 is not restricted by on-coming traffic.

FIG. 3 also depicts how safety distance 108 would be undershot by future path 110. Here, there is no no-passing zone, in contrast to the representation in FIG. 2. However, since an on-coming vehicle 300 is traveling on opposite traffic lane 106, available traffic space 116 is so small that here, too, vehicle 102 is unable to be guided on altered path 114. As a result, vehicle 102 is decelerated as in FIG. 2 and travels along behind bicycle 100 until opposite traffic lane 106 is free.

The function presented herein takes into account the fact that a lateral minimum distance with respect to the cyclist is not undershot, the speed is not exceeded, the center line is crossed only if this is permitted by the road rules and, as in FIG. 1, no on-coming traffic is present. If, as in FIG. 2, the space between center line 200 and cyclist is not sufficient, then no automatic passing maneuver may be initiated. The lines may be detected by an imaging sensor.

In one exemplary embodiment, the driver is asked via a user interface (HMI) whether a passing should still take place. In one exemplary embodiment, a warning occurs in the case of a deactivated adaptive cruise control (ACC) if the open space available for passing is not sufficient. If passing occurs manually, then the required distance in one exemplary embodiment is corrected by a slight steering intervention.

Finally, it is noted that terms such as “having”, “including”, etc. exclude no other elements or steps and terms such as “one” do not exclude a plurality.

1-13. (canceled)

14. A method for safe passing of a vehicle approaching a bicycle, the method comprising the following steps:
altering a future path of the vehicle in an automated manner when a safety distance with respect to a probable trajectory of the bicycle is undershot; and
guiding the vehicle on the altered path based on the altered path extending within an available traffic space.

15. The method as recited in claim 14, wherein the future path of the vehicle is altered in the automated manner based on pieces of sensor information of a sensor system of the vehicle, and the available traffic space is ascertained in an automated manner based on the pieces of sensor information.

16. The method as recited in claim 14, further comprising the following step:
altering a speed of the vehicle based on the altered path extending beyond the available traffic space.

17. The method as recited in claim 16, wherein the future path of the vehicle is re-determined using the altered speed and the method is repeated.

18. The method as recited in claim 14, wherein the future path is predicted using an instantaneous driver input.

19. The method as recited in claim 18, wherein the driver input is opposed by a counterforce when the driver input deviates from the altered path and/or from the altered speed.

20. The method as recited in claim 18, wherein a warning is output when the driver input deviates from the altered path and/or from the altered speed.

21. The method as recited in claim 14, wherein the available traffic space is determined using a piece of traffic sign information representing an identified traffic sign and/or a piece of roadway marking information representing identified roadway markings.

22. The method as recited in claim 14, wherein the available traffic space is determined using a piece of on-coming traffic information representing an identified on-coming traffic path.

23. The method as recited in claim 14, further comprising the following step:
activating a turn signal device of the vehicle before and during the passing.

24. A device for safe passing of a vehicle approaching a bicycle, the device configured to:
alter a future path of the vehicle in an automated manner when a safety distance with respect to a probable trajectory of the bicycle is undershot; and
guide the vehicle on the altered path based on the altered path extending within an available traffic space.

25. A non-transitory machine-readable memory medium on which is stored a computer program for safe passing of a vehicle approaching a bicycle, the computer program, when executed by a computer, causing the computer to perform the following steps:
altering a future path of the vehicle in an automated manner when a safety distance with respect to a probable trajectory of the bicycle is undershot; and
guiding the vehicle on the altered path based on the altered path extending within an available traffic space.
